(19) United States
(12) Patent Application Publication
(10) Pub. No.: US 2024/0090537 A1
(43) Pub. Date: Mar. 21, 2024

(54) Nanoencapsulation of Jania rubens seaweeds' antioxidants for food applications

(71) Applicant: The American University in Cairo, New York, NY (US)

(72) Inventors: Yasmin Raafat Maghraby, Cairo (EG); Adham Ramadan, Cairo (EG); Mohamed A. Farag, New Cairo (EG)

(21) Appl. No.: 18/274,283

(22) PCT Filed: Jan. 29, 2022
(86) PCT No.: PCT/US2022/014459

§ 371 Date: Jul. 26, 2023

Related U.S. Application Data
(60) Provisional application No. 63/143,393, filed on Jan. 29, 2021.

(51) Int. Cl. A23L 3/3472; A23D 9/06; A23L 3/3553; C11B 5/00

(52) U.S. Cl. CPC A23L 3/3472; A23D 9/06; A23L 3/3553; C11B 5/0071; C11B 5/0085

(57) ABSTRACT

An additive for food products to extend shelf-life is provided where the additive is nanoparticles having extracted phytochemicals or anti-oxidants from Jania Rubens nano-encapsulated with chitosan-tripolyphosphate. Shelf-life was extended in contrast to the synthetic preservatives which are typically used in the food industry. The cost of the natural preservative is much less than that of the synthetic preservatives. Extension of shelf-life by a natural source is nowadays more desirable by the consumers due to the modem trends of consumption of food with no chemical preservatives.

### FIELD OF THE INVENTION

The invention relates to methods for extending shelf-life of food products.

### BACKGROUND OF THE INVENTION

Lipid oxidation is a major degradative reaction limiting the shelf-life and deteriorating the quality of lipid containing food products. The oxidative deterioration of food products has a negative impact in the food industry in addition to the generation of potentially toxic products. Consequently, the inclusion of additives to slow down or stop the propagation of oxidation reactions is warranted, especially for prolonged storage durations. The present invention is directed towards technology to extend shelf-life of food products.

### SUMMARY OF THE INVENTION

The development of natural antioxidants that can mitigate oxidation reactions in food products is on the rise. Several antioxidants have been developed from natural terrestrial plants, with less emphasis on marine seaweeds. Rancidity is a major degradative reaction limiting the shelf-life and deteriorating the quality of lipid containing food products. In this invention, the inventors focused on Jania Rubens algal extract encapsulated by chitosan-tripolyphosphate in retarding lipid oxidation reactions in vegetable oils as a food model system. Phytochemicals were extracted from the seaweeds' matrices by means of an organic solvent.

The antioxidant efficacy of the algal extract was evaluated by means of many assays. Bioactive compounds were further identified using gas chromatography-mass spectrometry and liquid chromatography-mass spectrometry. To enhance the Jania Rubens' extract's efficacy, the phytochemicals were nanoencapsulated into chitosan-tripolyphosphate using the ionic gelation techniques. The optimum nanoformulation was characterized by transmission electron microscopy. It had a particle size of 161 nm, zeta potential of 31.2 my, polydispersity index of 0.211 and an entrapment efficiency of 99.7%.

An in-vitro phytochemicals' release study of the nanoencapsulated extract versus raw extract was performed by means of the dialysis bag diffusion method. This assay was carried out in two stimulation release media to mimic the intestinal and the gastric conditions. In addition, the ability of the optimum formula to extend the shelf-life of vegetable oils, corn, sunflower, soybean and palm oils, was based on peroxide value and thiobarbituric acid assays. Besides, headspace solid-phase microextraction was applied to detect the oils' volatiles as secondary markers of rancidity. The results revealed that the nanoencapsulated Jania Rubens' extract considerably reduced the rate of formation of the primary and secondary oxidation products in the oils.

In one embodiment the invention can be characterized as an additive for food products to extend shelf-life, where the additive are nanoparticles having extracted phytochemicals or anti-oxidants from Jania Rubens nano-encapsulated with chitosan-tripolyphosphate.

In another embodiment the invention can be characterized as a method of extending shelf-life of food products where the method distinguishes having nanoparticles having extracted phytochemicals or anti-oxidants from Jania Rubens nano-encapsulated with chitosan-tripolyphosphate, and adding the nanoparticles to a food product. An example of food products is corn oil, sunflower oil, soybean oil or palm oil.

Significant advantages are provided. Shelf-life was extended of vegetable oils by means of a natural additive, in contrast to the synthetic preservatives which are typically used in the food industry. The cost of the natural preservative is much less than that of the synthetic preservatives. Besides, the inventors were able to extend the shelf-life by a natural source which is nowadays becoming more desirable by the consumers due to the modern trends of consumption of food with no chemical preservatives.

### BRIEF DESCRIPTION OF THE DRAWINGS

FIG. 1 shows according to an exemplary embodiment of the invention a schematic presentation showing the cross-linking between the chitosan polymer and the Algal extract. The schematic presentation on the right shows the chitosan-tripolyphosphate (TPP) shell encapsulating the Jania Rubens algal extract. JCNP stands for Jania Rubens chitosan nanoparticles. 110=chitosan; 120=chitosan amino groups; 130=chitosan functional groups; 140=Jania Rubens algal extract; 150=Mixing step (mixing of the chitosan and algal extract solutions by agitation with a magnetic stirrer); 160=solution of chitosan and Jania Rubens algal extract; 170=sodium tripolyphosphate; 180=Homogenization (by means of a high pressure homogenizer to produce monodisperse small nanoparticles); 190=Chitosan-tripolyphosphate encapsulating the Jania Rubens algal extract.

FIGS. 2A-D show according to an exemplary embodiment of the invention extension of the shelf-life of oils expressed as primary oxidation products (peroxide value) versus time of storage in sunflower (FIG. 2A), corn (FIG. 2B), soybean (FIG. 2C) and palm oil (FIG. 2D), respectively. ‘Orange’ 210—oil with synthetic antioxidant, ‘green’ 220—oil with chitosan nanoparticles encapsulation the Jania Rubens extract, ‘grey’ 230—oil with raw extract, ‘blue’ 240—oil with pristine chitosan nanoparticles, ‘yellow’ 250—oil with no additives.

FIGS. 3A-D show according to an exemplary embodiment of the invention extension of the shelf life of oils expressed as secondary oxidation products (thiobarbituric acid value) versus time of storage in sunflower (FIG. 3A), corn (FIG. 3B), soybean (FIG. 3C) and palm oil (FIG. 3D), respectively. ‘Orange’ 310—oil with synthetic antioxidant, ‘green’ 320—oil with chitosan nanoparticles encapsulation the Jania Rubens extract, ‘grey’ 330—oil with raw extract, blue’ 340—oil with pristine chitosan nanoparticles, ‘yellow’ 350—oil with no additives.

### DETAILED DESCRIPTION

Jania Rubens

Jania Rubens is available throughout the different seasons in the shores by e.g. Alexandria, Egypt. Jania Rubens is rich in many vital bioactive compounds including flavonoids, diterpenes, carotenoids, vitamins, fatty acids, tannins, phytol, and many more secondary metabolites. The major classes of polyphenols have been found to be flavonoids and tannins, which are known to process an antioxidant activity. To date, a minute amount of research has been done on this specific seaweed.

Antioxidants Extracted from Jania Rubens

The antioxidant efficacy of the Jania Rubens algal extract has been shown to be high by means of two antioxidants assays, i.e., 2,2-diphenyl-1-picrylhydrazyl, ferric reducing antioxidant power. Total phenolic content and total flavonoid content assays were carried out and both assays showed that the algal extract is rich in polyphenols and flavonoids, which are potent antioxidants. Diverse phytochemicals which possess an antioxidant activity were isolated from Jania Rubens by using gas chromatography-mass spectrometry and liquid chromatography-mass spectrometry. The Jania Rubens' extract revealed abundance of fatty acids, e.g. syringic acid, benzene dicarboxylic acid, myristic acid, palmitelaidic acid, palmitic acid, heptadecanoic acid, dodecanoic acid, oleic acid, stearic acid, octanoic acid, itaconic acid, adipic acid, glycolic acid and arachidic acid, which exhibit an antioxidant activity. In addition to fatty acids, some alcohols were detected that exhibit an antioxidant activity e.g. 1,4-butanediol, diethylene glycol and glycerol. Several nitrogenous compounds were detected most of which exhibit an antioxidant effect including uracil, 1-propionylproline, pyrrolidine, 2-butyl-1-methyl, 3-pyridinol and 3-hydroxypicolinic acid. Detected sugars, which have an antioxidant effect, included galactopyranose, 2-O-glycerol-α-d-galactopyranoside and D-glucose. Other lypophilic metabolites identified with a potential antioxidant effect included phytol and neophytadiene. Table 1 below shows the algal phytochemicals detected by gas chromatography-mass spectrometry. Table 2 below shows the algal phytochemicals detected by liquid chromatography-mass spectrometry.

Examples of phytochemicals or anti-oxidants from Jania Rubens useful to be nano-encapsulated with chitosan-tripolyphosphate are, for example, polyphenols, flavonoids, phytol, neophytadiene, syringic acid, benzene dicarboxylic acid, myristic acid, palmitelaidic acid, palmitic acid, heptadecanoic acid, dodecanoic acid, oleic acid, stearic acid, octanoic acid, itaconic acid, adipic acid, glycolic acid, arachidic acid, 1,4-butanediol, diethylene glycol, glycerol, uracil, 1-propionylproline, pyrrolidine, 2-butyl-1-methyl, 3-pyridinol, 3-hydroxypicolinic acid, galactopyranose, 2-O-glycerol-α-d-galactopyranoside, or D-glucose, or any combination thereof. In one embodiment, polyphenols and flavonoids are recognized as the key phytochemicals or anti-oxidants from Jania Rubens useful to be nano-encapsulated with chitosan-tripolyphosphate. In another embodiment, at least polyphenols and flavonoids are recognized as the phytochemicals or anti-oxidants from Jania Rubens useful to be nano-encapsulated with chitosan-tripolyphosphate.

Encapsulation of Characterized Antioxidants

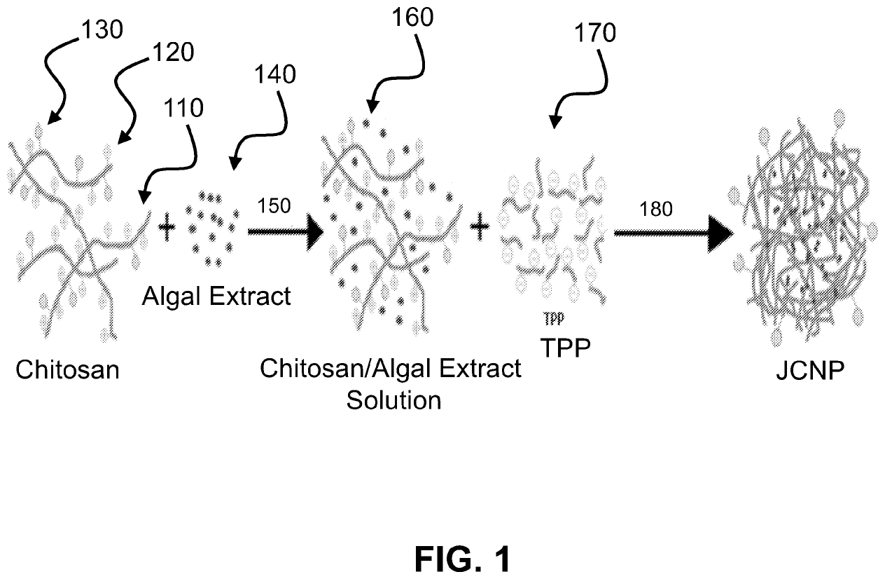

To further enhance the Jania Rubens' extract's efficacy, the algal extracts (i.e. antioxidants) were nanoencapsulated into chitosan-tripolyphosphate nanoparticles using an ionic gelation technique via high pressure homogenization. The optimum nanoformulation was characterized by scanning electron microscopy and transmission electron microscopy. The nanoformulation had a particle size of 161 nm, zeta potential of 31.2 my, polydispersity index of 0.211 and an entrapment efficiency of 99.7%. FIG. 1 shows a schematic presentation showing the cross-linking between the chitosan polymer and the Algal extract. The schematic presentation on the right shows the chitosan-tripolyphosphate shell encapsulating the Jania Rubens algal extract.

Shelf-Life

The nanoencapsulated Jania Rubens extracted antioxidant were added to oils to extend their shelf-life. The ability of the nanoparticle to extend the shelf-life of vegetable oils, corn, sunflower, soybean, and palm oils, was based on peroxide value and thiobarbituric acid assays. Additionally, headspace solid-phase microextraction was applied to detect the oils' volatiles as secondary markers of rancidity. The results revealed that the nanoencapsulated Jania Rubens' extract considerably reduced the rate of formation of the primary and secondary oxidation products in the oils. In other words, the nanoencapsulated Jania Rubens' extract extended the shelf life of the oils to a big extent, besides that its activity was comparable to that of a widely used synthetic antioxidant butylated hydroxytoluene.

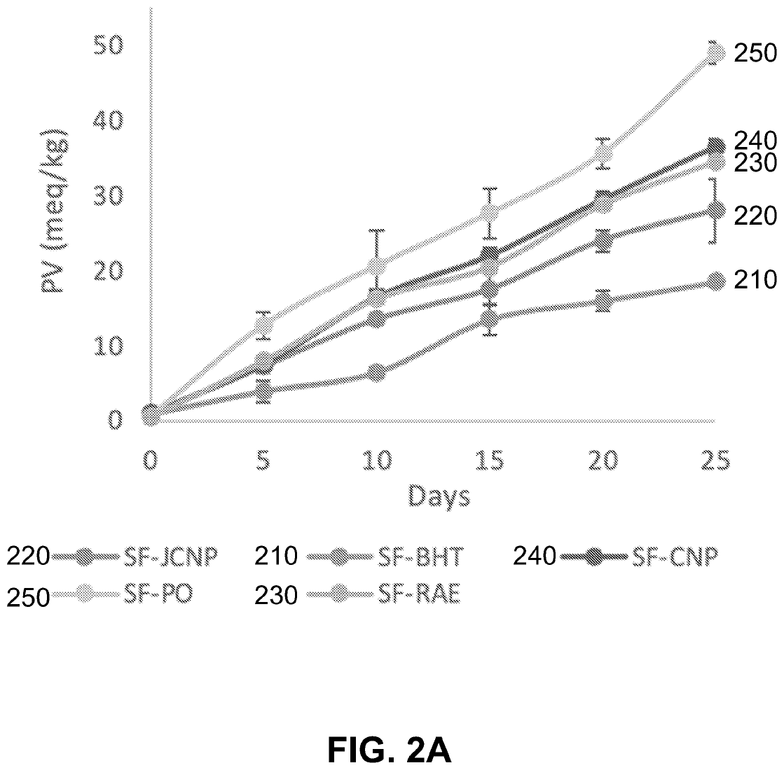

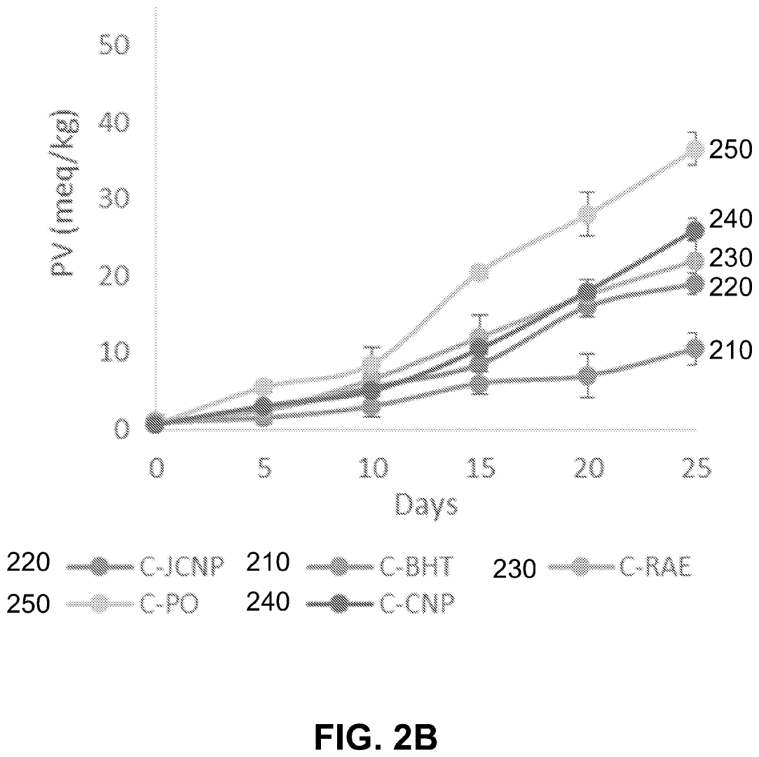

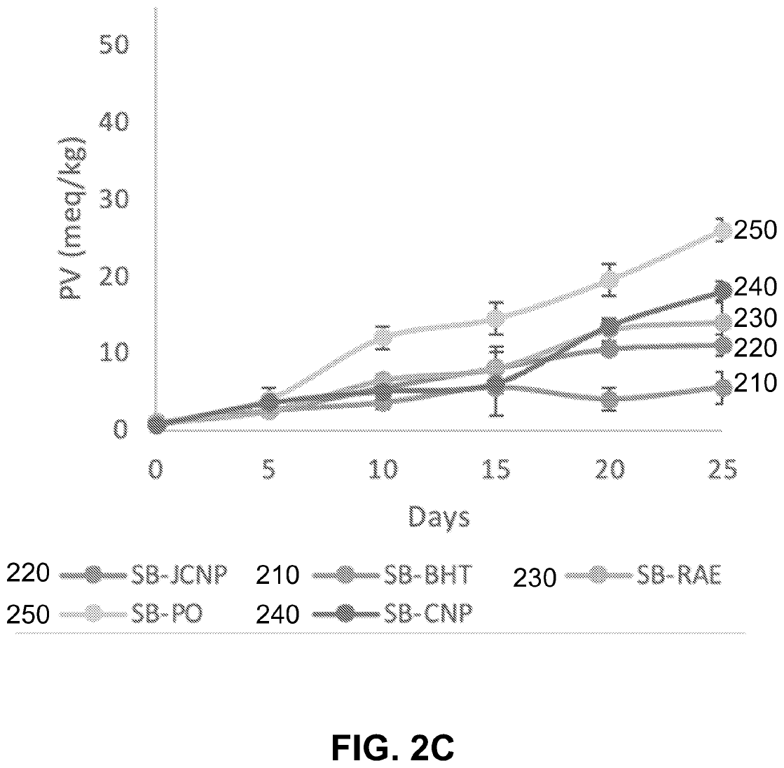

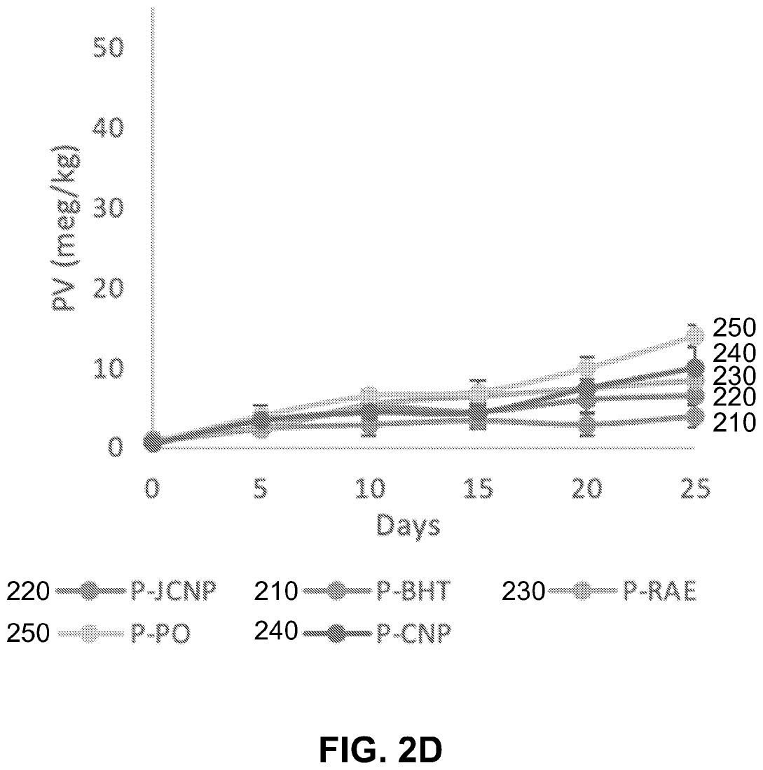

FIGS. 2A-D show the extension of the shelf-life of oils expressed as primary oxidation products (peroxide value) versus time of storage in sunflower (FIG. 2A), corn (FIG. 2B), soybean (FIG. 2C) and palm oil (FIG. 2D), respectively. ‘Orange’ 210—oil with synthetic antioxidant, ‘green’ 220—oil with chitosan nanoparticles encapsulation the Jania Rubens extract, ‘grey’ 230—oil with raw extract, ‘blue’ 240—oil with pristine chitosan nanoparticles, ‘yellow’ 250—oil with no additives.

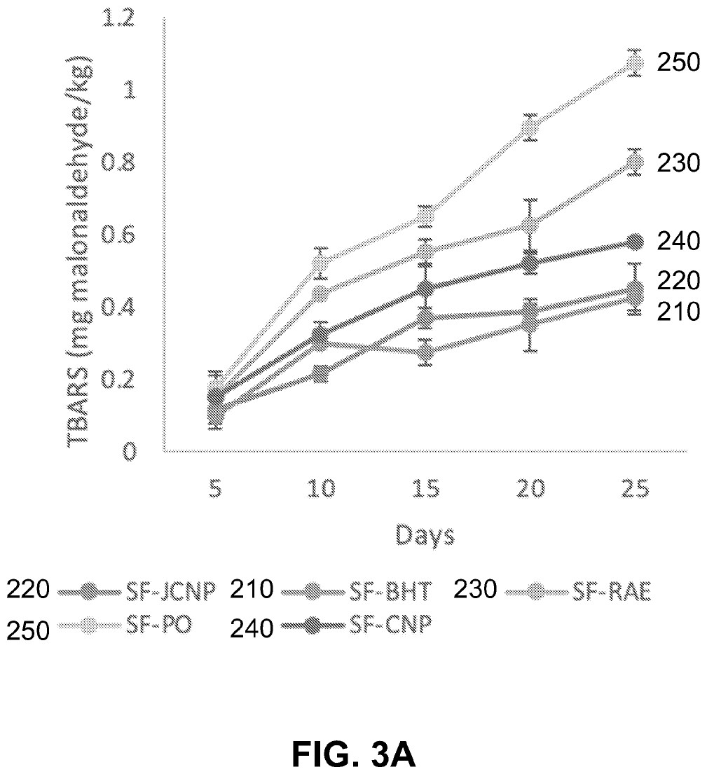

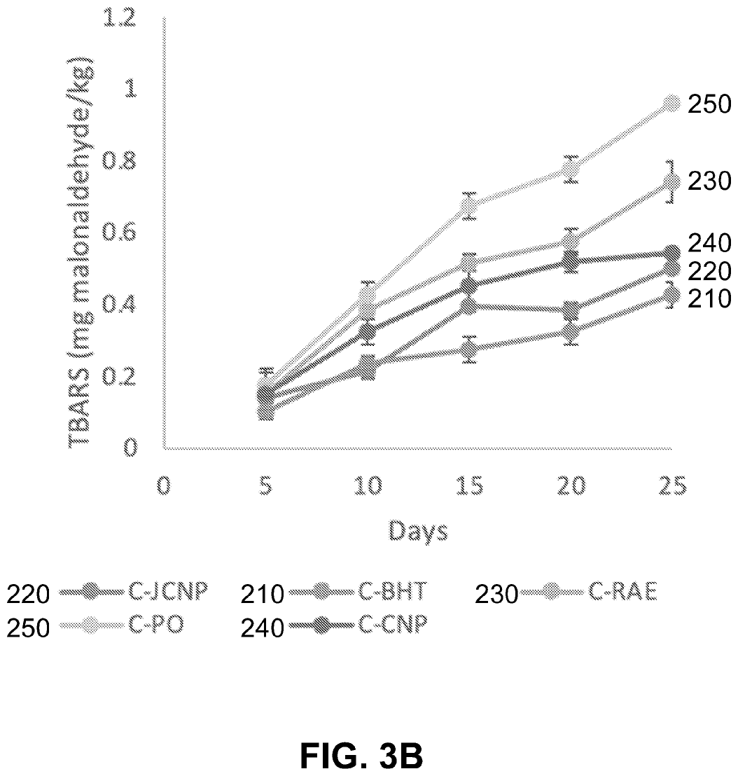

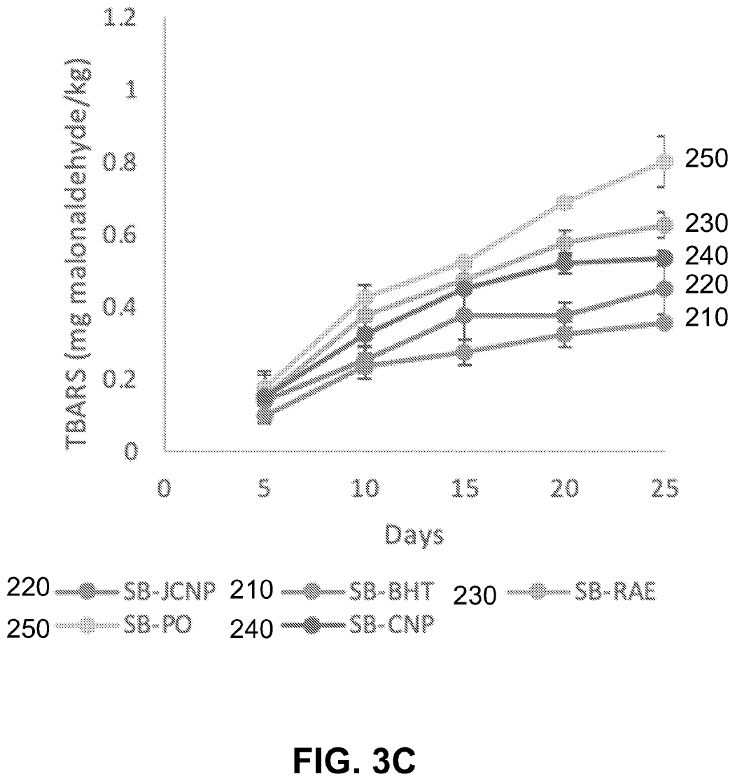

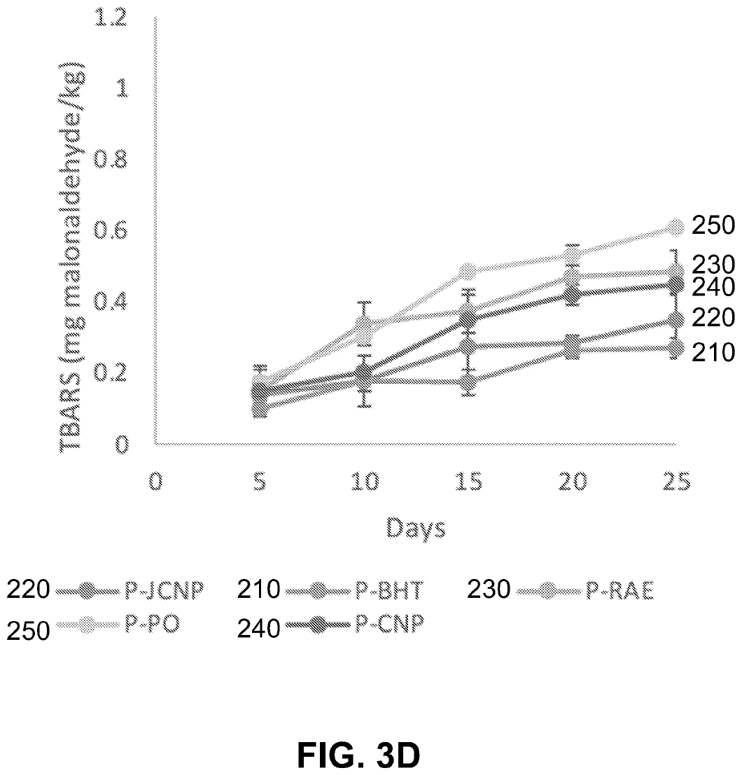

FIGS. 3A-D show the extension of the shelf life of oils expressed as secondary oxidation products (thiobarbituric acid value) versus time of storage in sunflower (FIG. 3A), corn (FIG. 3B), soybean (FIG. 3C) and palm oil (FIG. 3D), respectively. ‘Orange’ 310—oil with synthetic antioxidant, ‘green’ 320—oil with chitosan nanoparticles encapsulation the Jania Rubens extract, ‘grey’ 330—oil with raw extract, blue’ 340—oil with pristine chitosan nanoparticles, ‘yellow’ 350—oil with no additives.

TABLE 1
The algal phytochemicals detected by gas chromatography-mass spectrometry

| | Retention | | | | Molecular |
|---|---|---|---|---|---|
| Peak # | time (min) | KI | Area | Compound name | formula |
| 1 | 7.05 | 1084.7 | 1152 | Glycolic acid, 2TMS | C₂H₄O₃ |
| 2 | 8.61 | 1173.2 | 874 | Acetic acid | CH₃COOH |
| 3 | 9.76 | 1242.2 | 1306 | 4-Hydroxybutanoic acid | C₄H₈O₃ |
| 4 | 10.17 | 1268.8 | 1424 | Octanoic acid, TMS ester | C₈H₁₆O₂ |
| 5 | 11.57 | 1360.2 | 1782 | Itaconic acid, 2TMS | C₅H₆O₄ |
| 6 | 13.68 | 1512.6 | 897 | Adipic acid, 2TMS | C₆H₁₀O₄ |
| 7 | 14.27 | 1557.8 | 692 | Cinnamic acid | C₉H₈O₂ |
| 8 | 15.48 | 1654.6 | 714 | Dodecanoic acid | C₁₂H₂₄O₂ |
| 9 | 8.55 | 1168.8 | 3084 | 1,4-Butanediol | C₄H₁₀O₂ |
| 10 | 9.91 | 1252.2 | 1084 | Diethylene glycol, 2TMS | C₄H₁₀O₃ |
| 11 | 10.42 | 1285.6 | 7270 | Glycerol, 3TMS | C₃H₈O₃ |
| 12 | 7.47 | 1108.2 | 1182 | 3,4,5-Trimethylheptane | C₁₀H₂₂ |
| 13 | 16.02 | 1699.8 | 3232 | Heptadecane | C₁₇H₃₆ |
| 14 | 15.41 | 1648.4 | 961 | 4-Acetamido-1-phenylpyrazole | C₁₁H₁₁N₃O |
| 15 | 17.72 | 1849.1 | 1591 | Myristic acid, TMS | C₁₄H₂₈O₂ |
| 16 | 18.77 | 1947.7 | 1334 | Myristic acid, TMS | C₁₄H₂₈O₂ |
| 17 | 19.58 | 2026.7 | 17204 | Palmitelaidic acid-TMS | C₁₈H₃₄O₂ |
| 18 | 19.77 | 2045.9 | 21646 | Palmitic Acid-TMS | C₁₆H₃₂O₂ |
| 19 | 20.73 | 2144.8 | 452 | Heptadecanoic acid, TMS | C₁₇H₃₄O₂ |
| 20 | 21.43 | 2218.9 | 2416 | Oleic Acid-TMS | C₁₈H₃₄O₂ |
| 21 | 21.49 | 2225.3 | 1744 | Oleic Acid-TMS | C₁₈H₃₄O₂ |
| 22 | 21.64 | 2242.8 | 2637 | Stearic acid-TMS | C₁₈H₃₆O₂ |
| 23 | 23.37 | 2441.9 | 544 | Arachidic acid-TMS | C₂₀H₄₀O₂ |
| 24 | 10.90 | 1316.3 | 1353 | Unknown nitrogenous | — |
| | | | | compound | |
| 25 | 11.33 | 1344.7 | 4306 | Unknown nitrogenous | — |
| | | | | compound | |
| 26 | 11.41 | 1349.8 | 1069 | Uracil, 2TMS | C₄H₄N₂O₂ |
| 27 | 12.52 | 1425 | 1451 | Unknown nitrogenous | — |
| | | | | compound | |
| 28 | 12.74 | 1442.1 | 3221 | 1-Propionylproline, TMS | C₈H₁₃NO₃ |
| | | | | derivative | |
| 29 | 13.55 | 1502.9 | 1156 | Unknown nitrogenous | — |
| | | | | compound | |
| 30 | 23.76 | 2491.6 | 498 | Unknown nitrogenous | — |
| | | | | compound | |
| 31 | 7.60 | 115.6 | 962 | 2-Butyl-1-methylpyrrolidine | C₉H₁₉N |
| 32 | 8.12 | 1144.6 | 3372 | 3-Pyridinol, TMS | C₅H₅NO |
| 33 | 8.77 | 1181.0 | 1996 | 3-Hydroxypicolinic acid, 2TMS | C₆H₅NO₃ |
| 34 | 9.82 | 1246.4 | 1157 | Urea, 2TMS | CH₄N₂O |
| 35 | 12.33 | 1411.2 | 757 | Phloroglucinol, O,O′- | C₆H₆O₃ |
| | | | | bis(trimethylsilyl) | |
| 36 | 14.56 | 1579.3 | 1004 | Unknown steroid, TMS | — |
| 37 | 21.95 | 2276.9 | 1209 | Unknown sterol, TMS | — |
| 38 | 29.22 | 3182.4 | 3529 | Cholesterol, TMS | C₂₇H₄₆O |
| 39 | 19.34 | 2001.3 | 559 | Galactopyranose, 5TMS | C₆H₁₂O₆ |
| 40 | 21.88 | 2269.2 | 11343 | O-Glycerol-α-galactopyranoside | C₂₇H₆₆O₈ |
| 41 | 16.32 | 1726.1 | 566 | Levoglucosan, 3TMS | C₆H₁₀O₅ |
| 42 | 18.44 | 1916.8 | 470 | D-Glucose, 6 TMS | C₆H₁₂O₆ |
| 43 | 17.62 | 1839.6 | 670 | Neophytadiene | C₂₀H₃₈ |
| 44 | 17.90 | 1865.2 | 506 | Neophytadiene | C₂₀H₃₈ |
| 45 | 21.03 | 2176.3 | 6862 | Phytol, TMS derivative | C₂₀H₄₀O |

TABLE 2
The algal phytochemicals detected by liquid chromatography-mass spectrometry

| Peak | Rt | | | | Molecular | Error | |
|---|---|---|---|---|---|---|---|
| No | (min) | [M − H]− | Metabolite | MSⁿ ions (m/z) | Formula | (ppm) | Class |
| 1. | 0.51 | 200.96 | Dihydroxyphenyl | 183, 157, 110, | C₉H₁₁O₅— | 3.76 | Phenolics |
| | | | glycerol | 89 | | | |
| 2. | 0.51 | 272.96 | Dihydroxycoumarin | 255, 237, 228, | C₉H₅O₈S— | 5.78 | Coumarin |
| | | | sulfate | 214, 200, 187 | | | |
| 3. | 0.58 | 197.81 | Syringic acid | 170, 168, 153, | C₉H₉O₅— | 2.76 | Phenolics |
| | | | | 135 | | | |
| 4. | 10.54 | 187.10 | Laminine | 169, 160, 142, | C₉H₁₉N₂O₂— | 0.57 | Betaine |
| | | | | 125 | | | |
| 5. | 11.12 | 165.95 | Benzenedicarboxylic | 133, 122 | C₈H₅O₄— | 3.15 | Aromatic |
| | | | acid | | | | acid |
| 6. | 11.86 | 277.91 | Syringic acid sulfate | 197,165, 137 | C₉H₉O₈S— | 0.26 | Phenolics |
| 7. | 13.38 | 242.18 | Pentadecanoic acid | 225, 198, 181 | C₁₅H₂₉O₂— | −1.63 | Fatty acid |
| 8. | 14.89 | 323.22 | Hydroxyeicosadienoic | 305, 279, 197, | C₂₀H₃₅O₃— | 2.81 | Fatty acid |
| | | | acid | 183 | | | |
| 9. | 16.57 | 265.15 | Heptadecadienoic acid | 239, 221, 98 | C₁₇H₂₉O₂— | 1.92 | Fatty acid |
| 10. | 17.04 | 297.15 | Nonadecanoic acid | 279, 253, 197, | C₁₉H₃₇O₂— | 0.62 | Fatty acid |
| | | | | 183 | | | |
| 11. | 17.53 | 311.17 | Arachidic acid | 293, 267, 197, | C₂₀H₃₉O₂— | 1.73 | Fatty acid |
| | | | | 183 | | | |
| 12. | 18.61 | 325.18 | Arachidic acid methyl | 296, 267, | C₂₁H₄₁O₂— | 2.04 | Fatty acid |
| | | | ester | 225, 197, 183 | | | |
| 13. | 19.25 | 339.20 | Arachidic acid ethyl | 311, 295, 239, | C₂₂H₄₃O₂— | −0.90 | Fatty acid |
| | | | ester | 183 | | | |

What is claimed is:

1. An additive for food products to extend shelf-life, comprising: nanoparticles having extracted phytochemicals or anti-oxidants from Jania Rubens nano-encapsulated with chitosan-tripolyphosphate.

2. The additive as set forth in claim 1, wherein the phytochemicals or anti-oxidants are polyphenols and flavonoids.

3. A method of extending shelf-life of food products, comprising:
(a) having nanoparticles having extracted phytochemicals or anti-oxidants from Jania Rubens nano-encapsulated with chitosan-tripolyphosphate; and
(b) adding the nanoparticles to a food product.

4. The method as set forth in claim 1, wherein the food products are corn oil, sunflower oil, soybean oil or palm oil.

5. The method as set forth in claim 1, wherein the phytochemicals or anti-oxidants are polyphenols and flavonoids.
